(19) United States
(12) Patent Application Publication
(10) Pub. No.: US 2020/0316811 A1
(43) Pub. Date: Oct. 8, 2020

(54) REVERSIBLE SAW CHAIN

(71) Applicant: Walbro LLC, Tucson, AZ (US)

(72) Inventor: Donald C.J. Hodgkinson, Caro, MI (US)

(21) Appl. No.: 16/303,351

(22) PCT Filed: May 11, 2017
(86) PCT No.: PCT/US2017/032181

§ 371 Date: Nov. 20, 2018

Related U.S. Application Data
(60) Provisional application No. 62/341,997, filed on May 26, 2016.

(51) Int. Cl. B27B 33/14

(52) U.S. Cl. CPC B27B 33/142; B27B 17/02

(57) ABSTRACT

A reversible saw chain for a power chainsaw with a guide bar or blade may be a continuous loop of interconnected links with a plurality of spaced-apart cutting links and a plurality of connecting links. Each cutting link may include a first cutting surface facing a first direction and a second cutting surface facing a second direction that is opposite to the first direction, and a top plate extending between the first and second cutting surfaces and being not planar between these cutting surfaces. The top plate may have a first portion inclined inwardly away from the first cutting surface and a second portion inclined inwardly away from the second cutting surface and the first and second portions may be in a v-shaped configuration.

### REFERENCE TO A RELATED APPLICATION

This patent application claims the benefit of the earlier filed U.S. Provisional Application, Ser. No. 62/341,997 filed on May 26, 2016, which is incorporated herein by reference in its entirely.

### TECHNICAL FIELD

The present disclosure relates generally to power driven chainsaws and more particularly to a reversible saw chain for a chainsaw.

### BACKGROUND

Reversible or bi-directional saw chains are previously known which in use are received on a guide bar or blade of a chainsaw and driven by a power source such as an electric motor or combustion engine. These reversible saw chains may have cutter teeth links connected to cam links which orient the cutter teeth relative to the direction of movement of the saw chain to cut an object in contact with the chain.

### SUMMARY

In at least some implementations, a saw chain may be an endless loop of interconnected links with a plurality of spaced apart cutting links pivotly connected to connecting links. Each cutting link may include a first cutting surface facing a first direction and a second cutting surface facing a second direction opposite to the first direction and each cutting link may have a top plate extending between the first and second cutting surfaces with a portion on the top plate that is not planar between its associated cutting surfaces. The top plate may have a first laterally extending portion inclined inwardly away from the first cutting surface and a second laterally extending portion inclined inwardly away from the second cutting surface. Each laterally extending portion may be inclined at an acute included angle relative to the direction of motion of the chain or to a line through the centers of two spaced apart holes adjacent the ends of the cutting link through which other links are pivotly connected. Connecting links may include drive links which may include an inwardly projecting tooth configured to enable the saw chain to be driven in either direction.

### BRIEF DESCRIPTION OF THE DRAWINGS

The following detailed description of certain embodiments and best mode will be set forth with reference to the accompanying drawings, in which:

FIG. 1 is a top view of a portion of a saw chain having teeth arranged to cut when the chain is run in either direction;

FIG. 2 is a side view of the saw chain; and

FIG. 3 is an enlarged side view of a cutting link for the saw chain.

### DETAILED DESCRIPTION

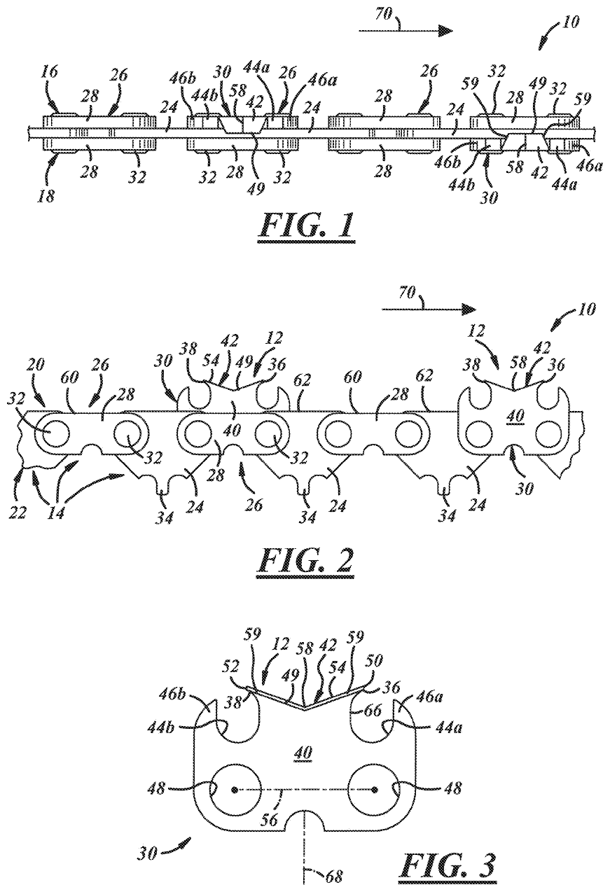

Referring in more detail to the drawings, FIGS. 1 and 2 illustrate a saw chain 10 for use on a chain saw, normally of the handheld, portable type driven by a power source such as an electric motor or combustion engine. The saw chain 10 forms an endless loop and is typically driven in one direction by the power source to cut an object in contact with the chain. To provide the cutting action, teeth 12 are spaced apart along the longitudinal length of the chain so that the teeth are driven with the chain 10 and relative to the object to be cut. The teeth 12 may be carried by or defined in one or more links 14 that are joined together with other links to provide the chain 10 in the form of a closed and continuous loop. The chain 10 may have laterally spaced left and right sides 16, 18 (FIG. 1), and exterior facing or outer side 20 and an interior facing or inner side 22 (FIG. 2).

The chain links may be of any desired design and configuration suitable to connect together adjacent links, including but not limited to links including cutting teeth 12. In the example shown, the chain 10 includes drive links 24 that are defined by a single plate received between double links 26 on either side of the drive link. The double links 26 have two plates disposed on each laterally facing (e.g. left and right) side of the drive link 24 so that the plate of the drive link 24 is trapped between the plates of the adjacent double links. The double links 26 may include two tie plates 28 without any cutting teeth 12, or one tie plate 28 and one cutting link 30 coupled together. In the example shown, the chain 10 alternates between double links 26 having a cutting link 30 and double links defined by two tie plates 28. The links 24, 26 may be coupled together by any desired connector 32 or fastener, including a rivet, pin, screw or the link, as desired. The connectors 32 may permit individual links 24, 26 to be removed from the chain 10 and repaired and reconnected to the chain, or replaced by a different link. To receive a connector 32, each plate of each link may include two spaced apart holes so that each link is coupled to the link on either side of the link. Of course, other styles of chain 10 may be utilized, the style of chain shown in the figures and described herein is just one example.

As shown in FIG. 2, the drive links 24 may include a drive feature 34 adapted to cooperate with a sprocket or other member driven by the chainsaw power source. In the example shown, the drive feature is or includes an inwardly projecting tooth 34, where inwardly is the direction toward an interior area bounded by the continuous chain 10. The tooth 34 may be received within a complementary slot in a sprocket rotated by the power source to drive the chain 10 relative to the sprocket and usually a guide bar of the chain saw.

The tie plates 28 may be of any size and shape, and in the example shown, serve only to interconnect and space apart the various drive links 24 and cutting links 30 in the chain 10. In most chains, the tie plates 28 do not engage the sprocket or the object to be cut.

The cutting links 30 are arranged in any suitable manner along the chain 10. As noted above, in at least some implementations the cutting links 30 are defined by a single plate that is coupled to a tie plate 28 to define a double link 26, and the double link is in turn coupled to adjacent drive links 24 at either longitudinal end of the double link. The cutting link 30 may include two opposed cutting surfaces with a first cutting surface 36 adapted to cut an object when the chain 10 is driven in a first direction or arranged in a first configuration, and a second cutting surface 38 adapted to cut an object when the chain is driven in a second direction that is opposite to the first direction, or arranged in a second configuration on the saw. For example, the chain 10 may be initially received on the chainsaw so that the first cutting surface 36 is arranged to cut an object and the second cutting surface 38 is not oriented to cut the object, and the chain may be removed from the chain saw and reconfigured to position the second cutting surface 38 so that the second cutting surface 38 is arranged to cut an object and the first cutting surface 36 is not oriented to cut the object.

In more detail, as shown in FIGS. 1-3, each cutting link 30 may include a generally flat main body 40, a top plate 42 that extends laterally from an upper portion of the main body 40, a recess or gullet (two 44a,b are shown) and an optional depth gauge projection (two 46a,b are shown). The main body 40 may include the holes 48 for the rivets or pins that couple the cutting link 30 to its associated tie plate 28, and to the adjacent drive links 24. The top plate 42 may extend laterally toward the tie plate 28 to which the cutting link 30 is connected to an inward edge 49, and may but need not overlie part or all of the tie plate. The cutting links 30 may be alternated so that one link is on the left side 16 of the chain 10 and the adjacent cutting links are on the right side 18, providing an alternating series of left hand and right hand cutting links. The main body 40 may have a portion to which the top plate 42 is connected that extends above the tie plate 28 and adjacent drive links 24 so that the top plate 42 is spaced from and does not engage the other links. The top plate 42 may be generally perpendicular to the main body 40 (where generally perpendicular means within 10 degrees of perpendicular. The first cutting surface 36 is defined on or at one end of the top plate 42 and may include a corner 50 or junction between that end of the top plate and main body 40, sometimes called a cutting corner. The second cutting surface 38 may be defined on the opposite end of the top plate 42 and may also include the corner 52 or junction between that end of the top plate 42 and the main body 40.

To inhibit or prevent the longitudinal length of an outer surface 54 of the top plate 42 from engaging and being dragged against an object to be cut, the top plate 42 in at least some implementations is not planar between its ends (i.e. at cutting surfaces 36, 38). In at least some implementations, at least a portion of the upper surface 54 of the top plate 42 is closer to an imaginary line 56 intersecting the center of both holes 48 of the cutting link 30 than are the ends of the top plate 42. Hence, the upper surface 54 of the top plate 42 is not parallel to the line 56. In the example shown, the top plate 42 is linearly inclined along its longitudinal length from each end to a mid-portion 58 of the top plate. Hence, the top plate 42 may be generally V-shaped with the ends of the top plate 42 defining the ends of the V, and the mid-portion 58 of the top plate defining the base of the V. The main body 40, at the juncture with the top plate 42, may also have the same general V-shape. That is, the main body 40 may have an increased height or distance from the line 56 near the ends of the top plate 42 and a reduced height between the ends. To locate the top plate 42 above the adjacent links (e.g. extending outwardly, away from the interior of the chain), a portion of the main body 40 extends above the upper surface 60 of the tie plate 28, and preferably also above an upper surface 62 of the drive links 24 (FIG. 2). Hence, a portion of the main body 40 and the top plate 42 extend outwardly and define an outermost portion of the saw chain 10. Further, the inward edge 49 of the top plate 42 may be shorter in length than the outer edge of the top plate (where the outer edge extends between corners 50 and 52), and transition edges 59 that extend laterally and are inclined longitudinally extend from the corners 50, 52 to the inward edge 49, as best shown in FIG. 1.

The gullets 44a,b may be provided adjacent to each cutting surface, and the gullets may be defined by a recess in the main body 40 formed outboard of the associated end of the top plate 42 and defined at least in part by a side edge 66 of the main body 40 that leads to the top plate 42. A first gullet 44a is adjacent to the first cutting surface 36 and extends below the top plate 42. A second gullet 44b is adjacent to the second cutting surface 38 and extends below the top plate 42. The gullet may help to remove chips or material removed from the object being cut, and direct such particles in a desired direction or manner. The depth guards 46 may be defined by projections of the main body 40 that are longitudinally spaced from the top plate 42 by the adjacent gullet 44a or b. In more detail, a first depth guard 46a is longitudinally spaced from the top plate 42 by the first gullet 44a and a second depth guard 46b is longitudinally spaced from the top plate by the second gullet 44b. The depth guards 46a,b may be arranged to position the chain relative to an object to be cut and limit the depth of engagement between the cutting link 30 and the object being cut. To this end, the depth guards 46a,b may be dull and not intended to cut the object. The depth guards 46a,b may extend outwardly beyond the upper surfaces 60, 62 of the adjacent tie plates 28 and drive links 24, but not as far as the top plate 42 and any cutting corner 50, 52 associated therewith, so that the cutting surface may satisfactorily engage the object to be cut. The cutting link 30 may be symmetrical about a centerline 68 perpendicular to the line 56 through the axis of the holes 48, so that the first cutting surface 36, first gullet 44a and first depth guard 46a are mirror images of the second cutting surface 38, second gullet 44b and second depth guard 46b. Of course, the cutting link 30 could have different characteristics associated with each side, for example, so that the second cutting surface 38 provides a different cut than the first cutting surface 36 in which case at least one of and up to all of the second cutting surface 38, gullet 44b or depth guard 46b may be different.

In the example shown, the chain 10 is driven in the direction indicated by arrow 70 (FIGS. 1 and 2) and the first cutting surface 36 is arranged for cutting. That is, in the direction of travel of the chain 10, the first cutting surface 36 leads the second cutting surface 38 and is oriented facing an object to be cut so that the first cutting surface cuts into the object when brought into contact with the object. The second cutting surface 38, on the other hand, trails the first cutting surface 36 in the direction of chain travel and faces away from an object to be cut relative to the direction of chain travel. The second cutting surface 38 does not cut the object when the second cutting surface is moved past the object. In this orientation and direction of chain travel, the first gullet 44a leads the first cutting surface 36 and the first depth guard 46a leads the first gullet.

The chain 10 may be removed from the chainsaw and reconfigured so that the second cutting surfaces 38 lead the first cutting surfaces 36 in the direction of chain travel, and so that the second cutting surfaces cut the object while the first cutting surfaces do not cut the object (e.g. rotated so that the left side becomes the right side and vice versa). This may be done, for example, when the first cutting surfaces 36 become dull to enable continued cutting with the same chain and without requiring sharpening of the cutting links. This may also be done to enable a different cut in instances when the first and second cutting surfaces 36, 38 are not mirror images of each other. At least when then cutting links 30 are symmetrical about the centerline 68, the chain 10 may be mounted on the chainsaw in either orientation whereas a chain with cutting links having only one cutting surface must be properly installed with the cutting surfaces leading a trailing edge of the cutting links. Accordingly, with the chain 10 set forth herein, initial installation is facilitated because the chain will function in either orientation. Further, the chain 10 may be used for twice as long before it needs to be serviced as there are two cutting surfaces 36, 38 for each cutting link 30. Further, the contoured top plate 42 reduces engagement of the top plate 42 with the object being cut to avoid undue rubbing of the top plate against the object, which can cause burned residue to build up (at least when the material being cut is wood), increases friction between the saw chain and the object being cut and can interfere with the engagement of the cutting surface with the object being cut. Still further, other solutions that allow reversal of the chain have fewer cutting surfaces oriented in each direction, for example, half of the cutting surfaces face one direction while the other half face the opposite direction. In the chain 10 disclosed herein, each cutting link 30 has two cutting surfaces 36, 38 with one cutting surface facing in each direction. Thus, the total number of cutting surfaces 36, 38 in each direction is equal to the number of cutting links 30 on the chain 10.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention.

1. A saw chain including interconnected links with a plurality of spaced apart cutting links and a plurality of connecting links coupled to the cutting links, each cutting link having a first cutting surface facing a first direction and a second cutting surface facing a second direction that is opposite to the first direction, and each cutting link has a top plate extending between the first cutting surface and the second cutting surface wherein at least a portion of the top plate is not planar between the first cutting surface and the second cutting surface.

2. The chain of claim 1 wherein each cutting link includes two spaced apart holes adjacent the blades thereof to receive fasteners coupling the cutting links to the adjacent connecting links and wherein at least a portion of the top plate of a cutting link is not parallel to a line intersecting the centers of the holes in the cutting link.

3. The chain of claim 2 wherein the top plate at the first cutting surface is farther from the line than is a portion of the top plate spaced from the first cutting surface.

4. The chain of claim 2 wherein the top plate at the second cutting surface is farther from the line than is a portion of the top plate spaced from the second cutting surface.

5. The chain of claim 2 wherein the top plate is inclined from the first cutting surface to a mid-portion and the top plate is inclined from the second cutting surface to the mid-portion so that the mid-portion is closer to the line than both the portion of the top plate adjacent to the first cutting surface and the portion of the opt plate adjacent to the second cutting surface.

6. The chain of claim 5 wherein the top surface has an outer surface that defines the outward most portion of the chain.

7. The chain of claim 1 wherein at least some of the connecting links are spaced apart drive links.

8. The chain of claim 7 wherein the drive links include an inwardly projecting tooth configured to enable the chain to be driven in either direction.
